(19) United States
(12) Patent Application Publication
(10) Pub. No.: US 2025/0289302 A1
(43) Pub. Date: Sep. 18, 2025

(54) Power Train for a Motor Vehicle

(71) Applicant: Bayerische Motoren Werke Aktiengesellschaft, Muenchen (DE)

(72) Inventors: Egon PIBINGER, Pasching (AT); Mario PRANDSTOETTER, Linz (AT)

(21) Appl. No.: 18/862,205

(22) PCT Filed: Mar. 24, 2023
(86) PCT No.: PCT/EP2023/057667

§ 371 Date: Nov. 1, 2024

(30) Foreign Application Priority Data
Jun. 15, 2022 (DE) 10 2022 115 120.4

(51) Int. Cl. B60K 7/00; B60K 17/04; F16H 57/00; F16H 57/02; F16H 57/021

(52) U.S. Cl. CPC B60K 7/0007; B60K 17/043; F16H 57/0018; F16H 57/021; B60K 2007/0061; F16H 2057/02034; F16H 2057/02052

(57) ABSTRACT

A power train for a motor vehicle includes at least one electric drive device, a first shaft which can be rotated relative to a housing element, and a second shaft which can be rotated relative to the housing element and which is designed as a hollow shaft at least in some regions. At least one longitudinal region of the first shaft is received in said hollow shaft in a rotatable manner relative to the second shaft. A first vehicle wheel can be driven by way of the electric drive device via the first shaft, and a second vehicle wheel can be driven by way of the electric drive device via the second shaft. An axial bearing is provided which rests against the first and second shaft and via which the shafts are supported against each other in the respective axial direction thereof in a rotatable manner relative to each other.

### BACKGROUND AND SUMMARY

This disclosure relates to a powertrain for a motor vehicle.

DE 10 2011 014 778 B4 discloses a concentric dual clutch device for arrangement in a powertrain of a motor vehicle between a drive unit and a transmission, the dual clutch device comprising a first clutch assembly, preferably multi-plate clutch assembly, particularly preferably wet-running multi-plate clutch assembly, assigned to a first transmission input shaft, for selective torque transmission between the drive unit and the first transmission input shaft, and a second clutch assembly, preferably multi-plate clutch assembly, particularly preferably wet-running multi-plate clutch assembly, assigned to a second transmission input shaft, for selective torque transmission between the drive unit and the second transmission input shaft.

It is an object of the disclosure to provide a powertrain for a motor vehicle, such that the motor vehicle can be driven particularly efficiently.

The disclosure relates to an in particular electric powertrain for an in particular electrically drivable motor vehicle. The motor vehicle is preferably in the form of a car, in particular in the form of a passenger car, commercial vehicle, or in the form of a truck. Preferably, the motor vehicle, in particular in its completely produced state, comprises the powertrain.

The powertrain comprises at least one electric drive device by way of which the motor vehicle is drivable. In other words, the electric drive device is able to be used to provide at least one torque intended to drive the motor vehicle. Preferably, the electric drive device comprises at least one electric machine by way of which the motor vehicle is drivable. The motor vehicle is preferably in the form of a battery electric vehicle or in the form of a hybrid vehicle. The motor vehicle is thus, for example, purely electrically drivable.

The powertrain comprises a first shaft which is rotatable, in particular about a first shaft rotational axis, relative to a housing element. The housing element may be part of the powertrain. The powertrain may thus comprise the housing element. For example, the housing element is formed as a housing element for a transmission of the powertrain and/or formed as a housing element for the drive device of the powertrain. As an alternative, the housing element may be formed separately from the powertrain. The housing element may thus, for example, be part of a housing for a structural element, formed separately from the powertrain, of the motor vehicle. The powertrain comprises a second shaft which is rotatable, in particular about a second shaft rotational axis, relative to the housing element. The second shaft is preferably formed separately from the first shaft. Preferably, the shafts are arranged coaxially with respect to one another. This means that the second shaft rotational axis is preferably arranged coaxially with respect to the first shaft rotational axis.

The second shaft is formed at least in certain regions, in particular completely, as a hollow shaft. This means that at least a subregion of the second shaft is formed as a hollow shaft. For example, the second shaft, in particular an inner lateral surface of the second shaft, at least partially, in particular completely, delimits a receiving space, in particular in a radial direction of the second shaft. For example, the receiving space is at least partially, in particular completely, surrounded by the second shaft, in particular by the inner lateral surface of the second shaft, in particular in a circumferential direction of the second shaft. The inner lateral surface can be understood in particular to mean an inwardly directed lateral surface or an internal lateral surface of the second shaft. The receiving space can in particular be referred to as cavity.

At least one length region of the first shaft is received in the hollow shaft, in particular in the receiving space, so as to be rotatable relative to the second shaft. In other words, the first shaft is arranged at least in certain regions within the hollow shaft, in particular in the receiving space, wherein the first shaft is rotatable, in particular about the first shaft rotational axis, relative to the second shaft. The shafts are thus rotatable, in particular about their respective shaft rotational axes, relative to one another.

For example, an outer lateral surface of the first shaft is at least partially, in particular completely, covered by the second shaft, in particular by the subregion of the second shaft or by the inner lateral surface of the second shaft, in particular in the radial direction of the first shaft. For example, the outer lateral surface of the first shaft is at least partially, in particular completely, surrounded by the second shaft, in particular by the length region of the second shaft or by the inner lateral surface of the second shaft, in particular in the circumferential direction of the first shaft. The outer lateral surface of the first shaft can be understood in particular to mean an external lateral surface of the first shaft or an outwardly directed lateral surface of the first shaft.

For driving the motor vehicle, the electric drive device is able to be used to drive a first vehicle wheel of the motor vehicle by way of the first shaft. In other words, for driving the motor vehicle, in particular for driving the first vehicle wheel, the electric drive device, in particular a rotor of the electric drive device, is torque-transmittingly connected or connectable to the first vehicle wheel by way of the first shaft. This means that the electric drive device, in particular the rotor, is torque-transmittingly, in particular mechanically, couplable or coupled to the first vehicle wheel by way of the first shaft.

In addition, for driving the motor vehicle, the electric drive device is able to be used to drive a second vehicle wheel, which differs in particular from the first vehicle wheel, of the motor vehicle by way of the second shaft. In other words, for driving the motor vehicle, the electric drive device, in particular the rotor or a further rotor, formed separately from the rotor, of the electric drive device, is torque-transmittingly connected or connectable to the second vehicle wheel by way of the second shaft. This means that the electric drive device, in particular the rotor or the further rotor, is torque-transmittingly, in particular mechanically, couplable or coupled to the second vehicle wheel by way of the second shaft.

The vehicle wheels are preferably spaced apart from one another. Particularly preferably, the vehicle wheels are spaced apart from one another in a vehicle transverse direction of the motor vehicle. The respective vehicle wheel can be understood in particular to mean a respective ground contact element of the motor vehicle. The vehicle wheels may be part of the powertrain or be formed separately from the powertrain.

Preferably, the vehicle wheels are arranged on an in particular common axle, in particular drive axle, of the motor vehicle. For example, the motor vehicle comprises a first axle which is referred to in particular as front axle. For example, the motor vehicle comprises a rear axle which is referred to in particular as second axle. The first and the second axles are preferably spaced apart from one another in a vehicle longitudinal direction of the motor vehicle. The second axle is preferably arranged behind the first axle in the vehicle longitudinal direction. For example, the first vehicle wheel and the second vehicle wheel are arranged on the first axle. As an alternative, the first vehicle wheel and the second vehicle wheel are for example arranged on the second axle. For example, the respective axle is formed as a respective drive axle of the motor vehicle. The respective axle can be understood in particular to mean a respective vehicle axle. The powertrain may be provided for a front drive of the motor vehicle and/or for a rear drive of the motor vehicle.

The fact that the vehicle wheels are spaced apart from one another in the vehicle transverse direction can be understood in particular to mean that the vehicle wheels are spaced apart from one another in the vehicle transverse direction when the powertrain is in its installed position in the motor vehicle.

In order to be able to drive the motor vehicle particularly efficiently, in particular with particularly low friction, the disclosure makes provision of an, in particular exactly one, axial bearing which bears, in particular directly, against the first and the second shaft and supports or is able to support the shafts in their respective axial directions on one another so as to be rotatable relative to one another. In other words, the first and the second shaft are mounted rotatably relative to one another by way of the axial bearing, or by way of the axial bearing. In other words again, the shafts are held on one another, in particular directly, in the axial direction of the shafts by way of the axial bearing so as to be rotatable relative to one another. For example, a force which is applied to the first shaft and acts in the axial direction of the first shaft is introducible into the second shaft or transmittable to the second shaft by way of the axial bearing. For example, a force which is applied to the second shaft and acts in the axial direction of the second shaft, and which can be referred to in particular as second force, is introducible into the first shaft or transmittable to the first shaft by way of the axial bearing. The respective shaft rotational axis of the respective shaft preferably runs parallel to the respective axial direction of the respective shaft.

Preferably, the axial bearing directly contacts the second shaft, in particular the subregion or the inner lateral surface. Preferably, the axial bearing directly contacts the first shaft, in particular the length region or the outer lateral surface.

The axial bearing can be understood in particular to mean a bearing which is in particular specifically designed or formed to withstand forces in the direction of the shaft, that is to say in the axial direction of the respective shaft. The axial bearing is thus not a radial bearing.

The disclosure is in particular based on the following realizations and considerations: a conventional bearing system concept for a conventional powertrain can usually exhibit particularly great bearing forces. The conventional bearing system concept can also usually exhibit non-optimal or particularly high power loss components. A conventional efficient bearing system, which for example comprises a fixed bearing/floating bearing combination, can for example have installation space-related disadvantages, with the result that the conventional efficient bearing concept can for example fit into the package of the powertrain or of the motor vehicle only with particular difficulty, if at all.

By contrast, the motor vehicle can be driven particularly efficiently, in particular with particularly low friction or particularly advantageously in terms of friction, by way of the powertrain according to the disclosure. In the case of a powertrain according to the disclosure, the first and the second shaft rotate relative to one another for example only when there is a wheel speed difference between the first and the second vehicle wheel. This means that, when the motor vehicle is driving straight ahead for example, the shafts rotate relative to the housing element, but do not rotate relative to one another, since the first and the second shaft for example have a respective identical speed relative to one another. This makes it possible to keep, in particular mechanical, friction, which is referred to in particular as bearing friction and can occur in the axial bearing, particularly when the motor vehicle is driving straight ahead, particularly low. Power loss of the axial bearing can thus be kept particularly low. For example, the shafts rotate relative to one another during cornering, in particular with a particularly low differential speed. In particular, owing to the particularly low differential speed, it is possible, particularly during cornering, for the bearing friction or the power loss to be kept particularly low. Furthermore, axial forces, for example the first and the second force, which act in the respective shaft or are applied to the respective shaft, in particular at least predominantly cancel each other out, as a result of which an in particular effective bearing force, in particular axial bearing force, which is applied in the axial bearing or to the axial bearing can be kept particularly low. This means that bearing forces acting in the axial bearing or on the axial bearing can be kept particularly low. The particularly low bearing forces make it possible to keep the bearing friction particularly low. In particular, the powertrain according to the disclosure can be used to keep an in particular electrical energy demand which is required or to be applied for driving the motor vehicle particularly low. In other words, the powertrain according to the disclosure can be used to particularly increase an electric range, in particular purely electric range, of the motor vehicle. Furthermore, an installation space for the powertrain can be particularly advantageously designed, in particular can be kept particularly small, for example due to the first shaft arranged in the hollow shaft. A bearing system for the shafts can thus be designed particularly efficiently or be kept particularly small with regard to a package of the powertrain or of the motor vehicle. In particular, due to the fact that the bearing forces can be kept particularly low, the robustness of the powertrain according to the disclosure can be particularly increased. The powertrain according to the disclosure is thus a particularly robust solution. This for example makes it possible to particularly increase the security in relation to damage to the powertrain. In particular, wear of the powertrain can be kept particularly low. This for example makes it possible to particularly increase the service life of the powertrain.

For example, the axial bearing comprises a first bearing part which is for example connected, in particular directly, to the first shaft, and the axial bearing for example comprises a second bearing part which is rotatable relative to the first bearing part and is for example connected, in particular directly, to the second shaft. The first bearing part is for example formed as an internal or inner bearing part. The second bearing part of the axial bearing is for example formed as an outer or external bearing part. It is thus possible, when the shafts rotate at the same speed, for there to be no relative rotation between the two bearing parts of the axial bearing. As a result, it is for example possible for there to be no friction force between the two bearing parts of the axial bearing.

In a further embodiment, it is provided that, in particular for driving the motor vehicle, in relation to the two vehicle wheels, the electric drive device is able to be used to drive exclusively the first vehicle wheel by way of the first shaft. In other words, in relation to the two vehicle wheels, the electric drive device, in particular the rotor, is torque-transmittingly connected or connectable exclusively to the first vehicle wheel by way of the first shaft. In other words again, the electric drive device is able to be used to drive the first vehicle wheel by way of the first shaft, the driving of the second vehicle wheel by way of the first shaft by way of the electric drive device being prevented. It is preferably provided here that, in particular for driving the motor vehicle, in relation to the two vehicle wheels, the electric drive device is able to be used to drive exclusively the second vehicle wheel by way of the second shaft. In other words, in relation to the two vehicle wheels, the electric drive device, in particular the rotor or the further rotor, is torque-transmittingly connectable or connected exclusively to the second vehicle wheel by way of the second shaft. In other words again, the electric drive device is able to be used to drive the second vehicle wheel by way of the second shaft, the driving of the first vehicle wheel by way of the second shaft by way of the electric drive device being prevented. This makes it possible to drive the vehicle wheels particularly advantageously, in particular individually.

In a further embodiment, provision is made for the axial bearing to be arranged, in particular completely, within the hollow shaft, in particular in the receiving space. In other words, the axial bearing is at least partially, in particular completely, covered, preferably directly, by the second shaft, in particular by the subregion or by the inner lateral surface. This makes it possible for the installation space for the powertrain to be designed particularly advantageously, in particular kept particularly small. The axial bearing is preferably arranged completely within the hollow shaft.

In a further embodiment, at least one transmission stage, referred to in particular as first transmission stage, is provided and is able to drive the first shaft by way of the electric drive device. In other words, the electric drive device, in particular the rotor, is torque-transmittingly connected or connectable to the first shaft by way of the first transmission stage. Preferably, at least a second transmission stage is provided, which differs from the first transmission stage and is able to drive the second shaft by way of the electric drive device. In other words, the electric drive device, in particular the rotor or the further rotor, is torque-transmittingly connected or connectable to the second shaft by way of the second transmission stage. The respective transmission stage can be used to convert a respective torque provided by the electric drive device during transmission or for transmission to the respective shaft, in particular to the respective vehicle wheel. This makes it possible for the motor vehicle, in particular the respective vehicle wheel, to be driven particularly advantageously.

Preferably, in relation to the first and the second shaft, the electric drive device is able to be used to drive exclusively the first shaft by way of the first transmission stage. Preferably, in relation to the first and the second shaft, the electric drive device is able to be used to drive exclusively the second shaft by way of the second transmission stage.

For example, the respective transmission stage in each case comprises two gears. The respective gear is for example formed as a respective spur gear. The first and the second transmission stage are preferably formed separately from one another. For example, the first and the second transmission stage are spaced apart from one another in particular in the vehicle transverse direction.

In a further embodiment, provision is made for the electric drive device to comprise two electric machines. The electric drive device can therefore be referred to in particular as a two-machine electric drive. For example, the respective electric machine comprises in each case a respective stator and in each case a respective rotor which is rotatable, in particular about a respective machine rotational axis, relative to the respective stator. An electric power can be converted into a respective mechanical power by way of the respective electric machines, as a result of which the respective rotor can be driven by the respective stator and, as a result, is rotatable about the respective machine rotational axis relative to the respective stator. The respective electric power can for example be provided by way of a respective on-board electrical system of the motor vehicle. The rotor of a first of the electric machines can be referred to in particular as first rotor. The stator of the first electric machine can be referred to in particular as first stator. The rotor of the second electric machine can be referred to in particular as second rotor. The stator of the second electric machine can be referred to in particular as second stator. For example, the first and the second electric machine are formed separately from one another.

Preferably, in relation to the two shafts, the first electric machine, in particular the first rotor, is able to be used to drive exclusively the first shaft, in particular by way of the first transmission stage. In other words, in relation to the first and the second shaft, the first electric machine, in particular the first rotor, is torque-transmittingly connected or connectable exclusively to the first shaft, in particular by way of the first transmission stage. This means that the first electric machine, in particular the first rotor, is able to be used to drive the first shaft, in particular by way of the first transmission stage, the driving of the second shaft by way of the first electric machine, in particular by way of the first rotor, being prevented. Preferably, in relation to the two shafts, the second electric machine, in particular the second rotor, is able to be used to drive exclusively the second shaft, in particular by way of the second transmission stage. In other words, in relation to the first and the second shaft, the second electric machine, in particular the second rotor, is torque-transmittingly connected or connectable exclusively to the second shaft, in particular by way of the second transmission stage. This means that the second electric machine, in particular the second rotor, is able to be used to drive the second shaft, in particular by way of the second transmission stage, the driving of the first shaft by way of the second electric machine, in particular by way of the second rotor, being prevented. This makes it possible for the motor vehicle, in particular the respective vehicle wheel, to be driven particularly advantageously. In particular, the vehicle wheels can be individually driven particularly advantageously, in particular with particularly little effort.

In a further embodiment, a first radial bearing is provided, which bears, in particular directly, against the first shaft and the housing element and for example directly supports the first shaft in its radial direction on the housing element, in particular so as to be rotatable relative to the housing element. In other words, the first shaft is mounted on the housing element or in the housing element so as to be rotatable relative to the housing element by way of the first radial bearing or by way of the first radial bearing. Preferably, the powertrain comprises a second radial bearing, which bears, in particular directly, against the second shaft and the housing element, is in particular formed separately from the first radial bearing and for example directly supports the second shaft in its radial direction on the housing element, in particular so as to be rotatable relative to the housing element. In other words, the second shaft is mounted on the housing element or in the housing element so as to be rotatable relative to the housing element by way of the second radial bearing or by way of the second radial bearing. As a result, a respective force which is applied in each case in the radial direction to the respective shaft can be particularly reliably supported by way of the radial bearing. This makes it possible to particularly increase an in particular mechanical load-bearing capacity of the powertrain.

For example, the respective radial bearing comprises a respective first bearing part, and a second respective bearing part which is rotatable relative to the respective first bearing part. The first bearing part of the first radial bearing is for example connected, in particular directly, to the second shaft. The first bearing part of the second radial bearing is for example connected, in particular directly, to the first shaft. The respective second bearing part of the respective radial bearing is for example connected, in particular directly, to the housing element. The first respective bearing part of the respective radial bearing is for example an inner or internal respective bearing part. The second bearing part of the respective radial bearing is for example an outer or external respective bearing part.

When the respective shaft rotates about its respective rotational axis relative to the housing element, in particular with shaft speeds that are the same or different from one another, the respective bearing parts of the respective radial bearing preferably rotate relative to one another, as a result of which a respective friction force, that is to say a respective power loss, may act in the respective radial bearing. When the speed of the shafts is the same, for example when the motor vehicle is driving straight ahead, the respective power loss component can thus act only in the radial bearings and not in the axial bearing. It is thus for example possible for a respective power loss or a respective power loss component to not be produced by all of the bearings of the powertrain, in particular due to the fact that not all of the bearings, in particular the respective bearing parts thereof, rotate relative to one another. This makes it possible for the motor vehicle to be driven particularly efficiently, in particular with particularly low friction.

For example, the respective radial bearing is formed in each case as a deep-groove ball bearing or as a cylindrical roller bearing. For example, the first radial bearing is formed as a deep-groove ball bearing and the second radial bearing is formed as a cylindrical roller bearing or vice versa. For example, both radial bearings are formed as cylindrical roller bearings or as deep-groove ball bearings. As a result, the shafts can be mounted particularly efficiently, in particular with particularly low friction or particularly advantageously in terms of friction.

The radial bearing can be understood in particular to mean a respective bearing which is in particular specifically designed or formed to withstand forces in the radial direction of the respective shaft. The respective radial bearing is thus not an axial bearing.

In a further embodiment, provision is made for a further bearing which is formed separately from the axial bearing, and in particular separately from the radial bearings, and preferably directly supports the shafts on one another, in particular in the axial direction, so as to be rotatable relative to one another to be arranged within the hollow shaft, in particular in the receiving space. In other words, the first and the second shaft are mounted rotatably relative to one another by way of the further bearing or by way of the further bearing. The further bearing is for example formed as an axial bearing. The further bearing can therefore be referred to in particular as second axial bearing. For example, a spacing, in particular running in the axial direction of the respective shaft, between the respective radial bearing and the axial bearing, referred to in particular as first axial bearing, and/or the second axial bearing can be particularly large. This means in particular that a respective bearing support span can be particularly increased. As a result, bearing forces which act in the respective radial bearing and run in particular in the radial direction of the respective shaft can be kept particularly low. This for example makes it possible for the respective radial bearings to be operated with particularly low friction. Furthermore, the stiffness of the, in particular radial, bearing system of the respective shaft can be particularly increased. This for example makes it possible to particularly increase the security in relation to, in particular elastic, tilting of a respective gear of the respective transmission stage. This makes it possible to avoid the elastic tilting or to keep it particularly low. This in particular makes it possible for a respective tooth engagement between the respective gears of the respective transmission stage to proceed particularly cleanly.

In a further embodiment, provision is made for the respective gears of the respective transmission stage to each have a respective helical toothing. In other words, the gears of the respective transmission stage are provided with helical toothing. This means that the respective gear of the respective transmission stage has a respective toothing which is in the form of helical toothing. This for example makes it possible to particularly improve the smooth running of the powertrain, in particular of the respective gear of the respective transmission stage. Furthermore, the development of noise in the powertrain, in particular at the respective gear of the respective transmission stage, can be kept particularly low. Axial forces which are brought about by the respective helical toothing and are applied to the respective shaft can, in particular outwardly, in particular at least predominantly, cancel each other out. In particular, due to the fact that the respective bearing parts of the respective axial bearing for example do not rotate relative to one another when the motor vehicle is driving straight ahead, but rather rotate relative to one another only during cornering, the axial forces brought about by the helical toothing cannot result in particularly increased power loss.

In a further embodiment, at least a third transmission stage is provided, which differs from the transmission stages and, in relation to a first torque flow running from the first electric machine, in particular via the first rotor, to the first vehicle wheel, is arranged upstream or downstream of the first shaft in the first torque flow between the first electric machine, in particular the first rotor, and the first vehicle wheel, as a result of which in particular the first torque flow runs via the third transmission stage. In other words, the first electric machine, in particular the first rotor, is able to be used to provide a first torque which is able to be used to drive the first shaft by way of the third transmission stage. As an alternative, the first torque is able to be used to drive the third transmission stage by way of the first shaft. Preferably, the powertrain comprises at least a fourth transmission stage, which differs from the transmission stages and, in relation to a second torque flow which runs from the second electric machine, in particular from the second rotor, to the second vehicle wheel and in particular differs from the first torque flow, is arranged upstream or downstream of the second shaft in the torque flow between the second electric machine, in particular the second rotor, and the second vehicle wheel, as a result of which in particular the second torque flow runs via the fourth transmission stage. In other words, the second electric machine, in particular the second rotor, is able to be used to provide a second torque which in particular differs from the first torque and is able to be used to drive the second shaft by way of the fourth transmission stage. As an alternative, the second torque is able to be used to drive the fourth transmission stage by way of the second shaft. As a result, the respective torque provided for driving the respective vehicle wheel can be converted particularly advantageously.

For example, the transmission stages are part of a transmission of the powertrain. In particular if the third transmission stage or the fourth transmission stage is arranged downstream of the respective shaft in relation to the respective torque flow, the respective shaft is for example formed as a respective intermediate shaft of the transmission. As a result, for example an installation space for the transmission can be designed particularly advantageously, in particular the installation space for the transmission can be kept particularly small. In particular, for example only a transmission housing may be required for the transmission. This makes it possible for the transmission, in particular the powertrain, to for example be produced with particularly little effort.

For example, the third transmission stage comprises two gears which are for example each formed as spur gears. For example, the fourth transmission stage comprises two gears which are for example each formed as spur gears.

For example, the first transmission stage and the second transmission stage are spaced apart from one another in the vehicle transverse direction. For example, the third transmission stage and the fourth transmission stage are spaced apart from one another in the vehicle transverse direction. For example, the first transmission stage and/or the third transmission stage are arranged on a first side in relation to the vehicle transverse direction of the motor vehicle. For example, the second transmission stage and/or the fourth transmission stage are arranged on a second side of the motor vehicle, which in particular differs from the first side, in relation to the vehicle transverse direction of the motor vehicle.

Preferably, it is provided that, in relation to the third and the fourth transmission stage, the first electric machine, in particular the first rotor, is able to be used to drive exclusively the third transmission stage. Preferably, it is provided that, in relation to the third transmission stage and the fourth transmission stage, the second electric machine, in particular the second rotor, is able to be used to drive exclusively the fourth transmission stage.

In a further embodiment, provision is made for at least one gear of the first transmission stage and/or of the third transmission stage to be arranged in a first receiving region which is at least partially delimited by the housing element. Provision is preferably made here for at least one gear of the second transmission stage and/or of the fourth transmission stage to be arranged in a second receiving region which is at least partially delimited by the housing element and is spaced apart from the first receiving region in particular in the respective axial direction of the respective shaft, for example spaced apart in the vehicle transverse direction of the motor vehicle. In other words, the first transmission stage and/or the third transmission stage are at least partially arranged in the first receiving region and the second transmission stage and the fourth transmission stage are at least partially arranged in the second receiving region, wherein a spacing is provided between the receiving regions and preferably runs in the axial direction of the respective shaft, for example in the vehicle transverse direction.

Provision is preferably made for the receiving regions to be fluidically connected or connectable to one another by way of at least one passage opening. In other words, the receiving regions are fluidically coupled or couplable to one another. In other words again, a respective fluid, for example air, located in the respective receiving region is able to be circulated or exchanged between the receiving regions. It is thus for example possible for at least part of the fluid located in the first receiving region to be discharged from the first receiving region and introduced into the second receiving region via the passage opening and vice versa. This makes it possible for a housing ventilation system, in particular for the transmission, to be designed particularly advantageously. In particular, it is possible to dispense with a respective separate housing ventilation system for the respective receiving region, with the result that for example only one, in particular exactly one, housing ventilation system may be necessary. This makes it possible for the installation space for the powertrain to be designed particularly advantageously, in particular kept particularly small. In particular, costs, for example production costs, for the powertrain can be kept particularly low.

The passage opening is preferably arranged in a vehicle vertical direction below the shafts. At least part of the respective receiving region is preferably arranged in the vehicle vertical direction below the shafts.

For example, the respective receiving region is in each case formed as a respective reservoir designed to receive oil. This can be understood in particular to mean the following: for example, the powertrain comprises a first reservoir, which is designed to receive oil and is able to supply the first transmission stage and/or the third transmission stage with the oil received in the first reservoir. For example, the powertrain comprises a second reservoir, which is designed to receive oil, is spaced apart from the first reservoir, in particular in the respective axial direction of the respective shaft, preferably spaced apart in the vehicle transverse direction, and is able to supply the second transmission stage and/or the fourth transmission stage with the oil received in the second reservoir. The reservoirs are fluidically connected, in particular directly, to one another via the passage opening. The fluid can thus, for example, be oil. The receiving regions or the reservoirs may thus form a common oil chamber or a common oil circuit. This makes it possible for the oil located in the respective reservoir to for example slosh back and forth into the respective other reservoir particularly when the motor vehicle is driving around corners. This for example makes it possible to ensure, during cornering, in particular in the direction of the vehicle wheel which is loaded particularly heavily or more heavily during the cornering, that a particularly great or sufficient amount of oil is located at bearings or gears of the respective transmission element that are located on the side of the particularly heavily loaded vehicle wheel. In particular, for example in the case of particularly great transverse acceleration, it is possible to avoid the situation in which the oil does not pass into an air gap of the respective electric machine, in particular between the respective stator and the respective rotor.

Further features of the disclosure will emerge from the figures and from the description of the figures. The features and feature combinations mentioned above in the description, and the features and feature combinations mentioned below in the description of the figures and/or only shown in the figures, may be used not only in the respectively specified combination but also in other combinations or individually.

### BRIEF DESCRIPTION OF THE DRAWINGS

The disclosure will now be explained in more detail on the basis of preferred exemplary embodiments and with reference to the drawings.

FIG. 1 shows a schematic partial sectional view of a powertrain according to the disclosure;

FIG. 2 shows a schematic partial sectional view of two shafts of a powertrain according to the disclosure;

FIG. 3 shows a schematic perspective view of two transmission elements of a powertrain according to the disclosure;

FIG. 4 shows a schematic partial sectional view of a powertrain according to the disclosure according to a further embodiment;

FIG. 5 shows a schematic lateral partial sectional view of a powertrain according to the disclosure according to a further embodiment; and,

FIG. 6 shows a schematic partial sectional view of two shafts of a powertrain according to the disclosure according to a further embodiment.

In the figures, identical or functionally identical elements are denoted by the same reference designations.

### DETAILED DESCRIPTION OF THE DRAWINGS

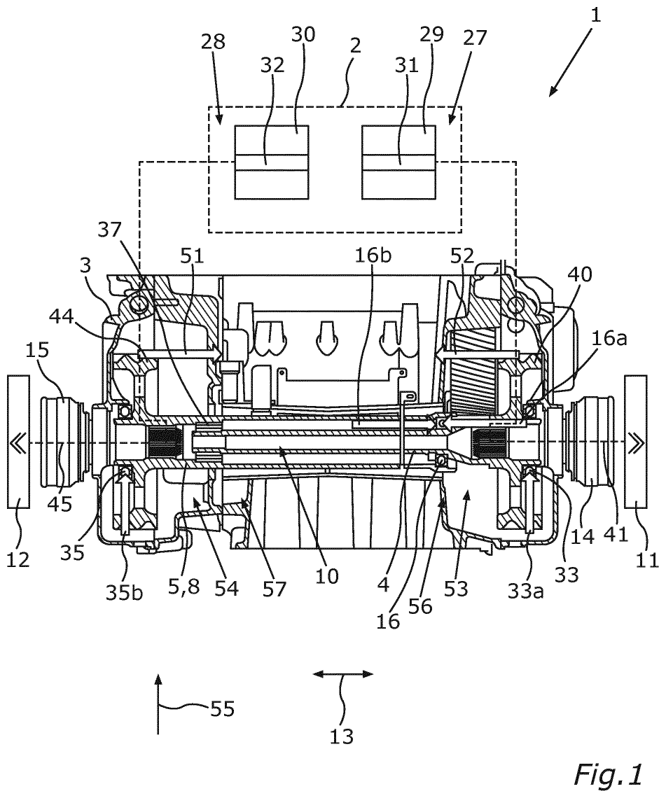

FIG. 1 shows a schematic partial sectional view of a powertrain 1 for an in particular electrically drivable motor vehicle. The powertrain 1 comprises at least one electric drive device 2 by way of which the motor vehicle is drivable. The powertrain 1 comprises at least one housing element 3 which is for example formed as a housing for the powertrain 1 or as a housing part of the housing.

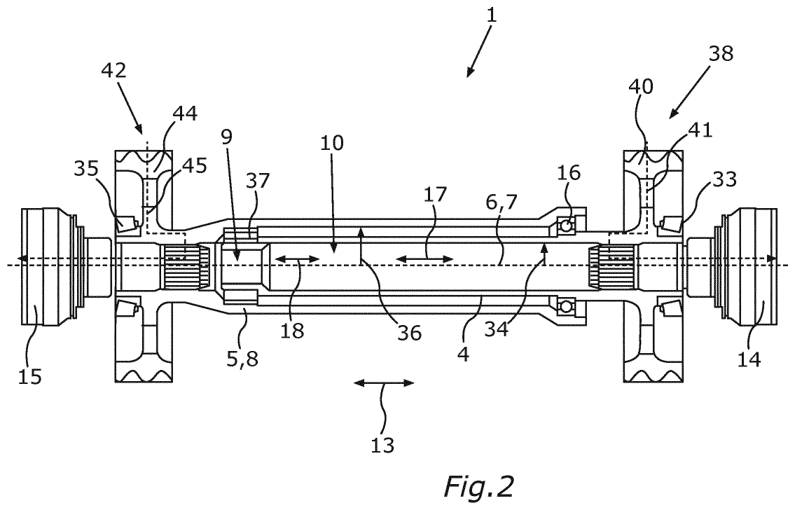

The powertrain 1 comprises a first shaft 4 and a second shaft 5 which is formed separately from the first shaft 4. FIG. 2 shows the shafts 4, 5 in a schematic partial sectional view. In the exemplary embodiment, the shafts 4, 5 are arranged coaxially with respect to one another. The first shaft 4 is rotatable, in particular about a first shaft rotational axis 6, relative to the housing element 3. The second shaft 5 is rotatable, in particular about a second shaft rotational axis 7, relative to the housing element 3. The shaft rotational axes 6, 7 are preferably arranged coaxially with respect to one another.

The second shaft 5 is formed at least in certain regions as a hollow shaft 8. For example, the second shaft 5 at least partially, in particular completely, delimits a receiving space 9. The receiving space 9 is arranged within the second shaft 5 or within the hollow shaft 8. At least one length region 10 of the first shaft 4 is received in the hollow shaft 8, in particular in the receiving space 9, so as to be rotatable relative to the second shaft 5.

The motor vehicle comprises a first vehicle wheel 11 and a second vehicle wheel 12 which is formed separately from the first vehicle wheel 11. The vehicle wheels 11, 12 are preferably spaced apart from one another in the vehicle transverse direction 13 of the motor vehicle. For example, the motor vehicle comprises four, in particular exactly four, vehicle wheels. This means that the motor vehicle can for example comprise a third vehicle wheel and a fourth vehicle wheel in addition to the vehicle wheels 11, 12. The respective vehicle wheel 11, 12 is rotatable about a respective wheel rotational axis of the respective vehicle wheel relative to the housing element 3. The respective shaft rotational axis 6, 7 preferably runs parallel to the vehicle transverse direction 13.

For driving the motor vehicle, the electric drive device 2 is able to be used to, in particular directly, drive the first vehicle wheel 11 of the motor vehicle by way of the first shaft 4. For driving the motor vehicle, the electric drive device 2 is able to be used to, in particular directly, drive the second vehicle wheel 12 by way of the second shaft 5. Thus, the first shaft 4 is for example assigned to the first vehicle wheel 11 and the second shaft 5 is for example assigned to the second vehicle wheel 12. In the exemplary embodiment shown in FIG. 1 and FIG. 2, the first vehicle wheel 11 is drivable, in particular directly, by the first shaft 4 by way of a first connecting element 14 and the second vehicle wheel 12 is drivable, in particular directly, by the second shaft 5 by way of a second connecting element 15 which is in particular formed separately from the first connecting element 14. The powertrain 1 may comprise the respective connecting element 14, 15. The first connecting element 14 may be part of the first vehicle wheel 11 or be formed separately from the first vehicle wheel 11. For example, the first connecting element 14 is formed as a wheel hub of the first vehicle wheel 11. The second connecting element 15 may be part of the second vehicle wheel 12 or be formed separately from the second vehicle wheel 12. For example, the second connecting element 15 is formed as a wheel hub of the second vehicle wheel 12.

In order to be able to drive the motor vehicle particularly efficiently by way of the powertrain 1, at least one axial bearing 16 is provided, which bears, in particular directly, against the first and the second shaft 4, 5 and supports or is able to support the shafts 4, 5 in their respective axial directions 17, 18 on one another, in particular directly, so as to be rotatable relative to one another. As a result, axial forces which run in the respective axial direction 17, 18 and are applied to the respective shaft 4, 5 can in particular at least partially or at least predominantly cancel each other out and thus no longer act against the housing element 3. This makes it possible for the powertrain 1 to be operated with particularly low friction. In particular, the two shafts 4, 5 can rotate relative to one another with particularly low friction. In particular, the respective axial force can be supported on or maintained at the axial bearing 16. Furthermore, when the first and the second vehicle wheel 11, 12 rotate with the same respective wheel speed, the shafts 4, 5 can rotate relative to the housing element 3 with particularly low friction. A mechanical friction, which is referred to in particular as bearing friction and acts in the axial bearing 16, can be kept particularly low here. This means that for example bearing parts of the axial bearing 16 do not rotate relative to one another when the wheel speed of the vehicle wheels 11, 12 is the same or when the shaft speed of the shafts 4, 5 is the same. For example, the bearing parts of the axial bearing 16 can rotate relative to one another only when the wheel speed of the vehicle wheels 11, 12 differs or the shaft speed of the shafts 4, 5 differs with a corresponding differential speed, for example during cornering. Thus, in the axial bearing 16, only the differential speed can contribute to the mechanical friction, as a result of which the mechanical friction can be kept particularly low. The supporting of the shafts 4, 5 on one another by way of the axial bearing 16 is illustrated in FIG. 1 by way of arrows 16a, 16b.

The axial direction 17 of the first shaft 4 can be referred to in particular as first axial direction 17. The axial direction 18 of the second shaft 5 can be referred to in particular as second axial direction. The respective axial direction 17, 18 preferably runs parallel to the vehicle transverse direction 13.

Preferably, it is provided that, in relation to the two vehicle wheels 11, 12, the electric drive device 2 is able to be used to drive exclusively the first vehicle wheel 11 by way of the first shaft 4, and, in relation to the two vehicle wheels 11, 12, the electric drive device 2 is able to be used to drive exclusively the second vehicle wheel 12 by way of the second shaft 5. This means that for example the first vehicle wheel 11 is drivable by way of the electric drive device 2 by way of the first shaft 4, whilst the driving of the second vehicle wheel 12 by way of the first shaft 4 is prevented, and for example the second vehicle wheel 12 is drivable by way of the electric drive device 2 by way of the second shaft 5, whilst the driving of the first vehicle wheel 11 by way of the second shaft 5 is prevented.

The axial bearing 16 is preferably arranged within the hollow shaft 8, in particular in the receiving space 9.

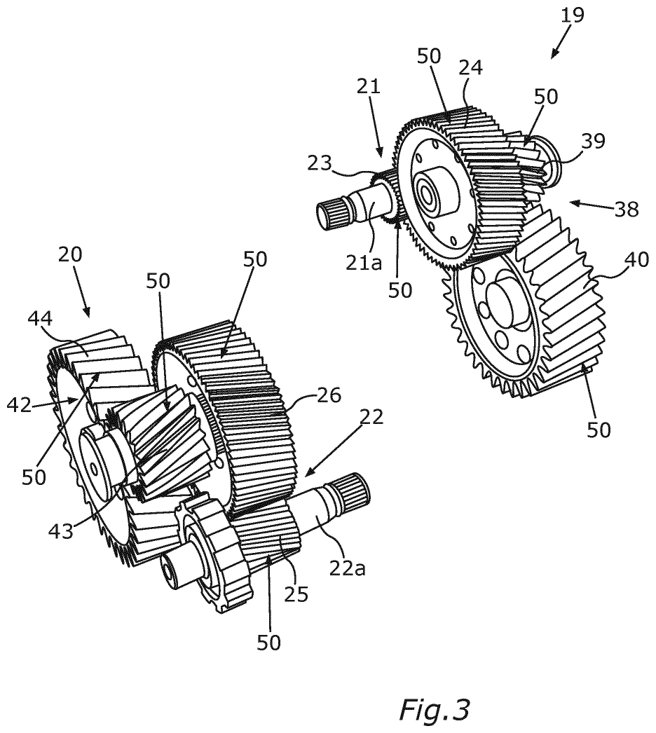

In a further embodiment, provision is made for the powertrain 1 to comprise at least one transmission element 19, which is referred to in particular as transmission, for example two transmission elements 19, 20. FIG. 3 shows the transmission elements 19, 20 in a schematic perspective view. Preferably, a first of the transmission elements 19 is assigned to the first shaft 4 and the second of the transmission elements 20 is assigned to the second shaft 5. This means that the first shaft 4 is drivable by way of the electric drive device 2, in particular in relation to the transmission elements 19, 20, exclusively by way of the first transmission element 19 and for example the second shaft 5 is drivable by way of the electric drive device 2, in particular in relation to the transmission elements 19, 20, exclusively by way of the second transmission element 20.

Preferably, the respective transmission element 19, 20 in each case comprises at least one transmission stage 21, 22. The transmission stage 21 of the first transmission element 19 can be referred to in particular as first transmission stage 21. The transmission stage 22 of the second transmission element 20 can be referred to in particular as second transmission stage 22. Thus, the first shaft 4 is drivable by way of the electric drive device 2 by way of the first transmission stage 21 and the second shaft 5 is drivable by way of the electric drive device 2 by way of the second transmission stage 22, which differs in particular from the first transmission stage 21.

Preferably, the respective transmission stage 21, 22 in each case comprises two gears 23-26 which are for example each formed as a respective spur gear. A first of the gears 23 of the first transmission stage 21 preferably meshes, in particular directly, with the second of the gears 24 of the first transmission stage 21. Preferably, the second gear 24 of the first transmission stage 21 is drivable by the first gear 23 of the first transmission stage 21. A first of the gears 25 of the second transmission stage 22 preferably meshes, in particular directly, with the second of the gears 26 of the second transmission stage 22. Preferably, the second gear 26 of the second transmission stage 22 is drivable, in particular directly, by the first gear 25 of the second transmission stage 22.

In a further embodiment, provision is made for the electric drive device 2 to comprise two, in particular exactly two, electric machines 27, 28. The respective electric machine 27, 28 in each case comprises a respective stator 29, 30 and a rotor 31, 32 which is rotatable relative to the respective stator 29, 30. The respective stator 29, 30 is preferably connected to a respective machine housing of the respective electric machine 27, 28, wherein the respective machine housing can for example be formed by the housing element 3. The stator 29 of the first electric machine 27 can be referred to in particular as first stator 29. The stator 30 of the second electric machine 28 can be referred to in particular as second stator. The rotor 31 of the first electric machine 27 can be referred to in particular as first rotor 31. The rotor 32 of the second electric machine 28 can be referred to in particular as second rotor 32. Preferably, in relation to the two shafts 4, 5, the first electric machine 27, in particular the first rotor 31, is able to be used to drive exclusively the first shaft 4, in particular by way of the first transmission stage 21. Preferably, in relation to the two shafts 4, 5, the second electric machine 28, in particular the second rotor 32, is able to be used to drive exclusively the second shaft 5, in particular by way of the second transmission stage 22.

The first rotor 31 is for example torque-transmittingly connected or connectable, in particular for conjoint rotation, to an input shaft 21a of the first transmission stage 21. The first gear 23 of the first transmission stage 21 is for example arranged on the input shaft 21a and connected for conjoint rotation to the input shaft 21a. For example, the second rotor 32 is torque-transmittingly connected or connectable, in particular for conjoint rotation, to an input shaft 22a of the second transmission stage 22. The first gear 25 of the second transmission stage 22 is for example arranged on the input shaft 22a and connected for conjoint rotation to the input shaft 22a.

For example, the electric drive device 2 comprises at least one inverter, for example two inverters. For example, a first of the inverters is assigned to the first electric machine 27 and the second of the inverters is assigned to the second electric machine 28. The respective inverter can be understood in particular to mean a respective power inverter.

In a further embodiment, a first radial bearing 33 is provided, which bears, in particular directly, against the first shaft 4 and against the housing element 3 and supports the first shaft 4 in its radial direction 34 on the housing element 3, in particular so as to be rotatable relative to the housing element 3. Furthermore, a second radial bearing 35 is provided, which bears, in particular directly, against the second shaft 5 and against the housing element 3 and supports the second shaft 5 in its radial direction 36 on the housing element 3, in particular so as to be rotatable relative to the housing element 3. The supporting of the respective shaft 4, 5 in the respective radial direction 34, 36 by way of the respective radial bearing 33, 35 on the housing element 3 is illustrated in FIG. 1 by way of a respective arrow 33a, 35a. For example, one of the radial bearings 33, 35 is formed as a deep-groove ball bearing and the other of the radial bearings 33, 35 is for example formed as a cylindrical roller bearing. As an alternative, both radial bearings 33, 35 are for example formed as annular ball bearings.

In the exemplary embodiment, a further bearing 37 which is formed separately from the axial bearing 16, and in particular separately from the radial bearings 33, 35, and supports the shafts 4, 5 on one another, in particular directly, in particular in their respective axial directions 17, 18, so as to be rotatable relative to one another is arranged within the hollow shaft 8, in particular in the receiving space 9. The further bearing 37 is preferably formed as an axial bearing. The further bearing 37 can therefore be referred to in particular as second axial bearing.

In particular, in the bearing system concept for the shafts 4, 5 which is shown in the exemplary embodiment, a particularly long respective support length can be brought about. This can in particular be brought about by a spacing between the first radial bearing 33 and the axial bearing 16, and also the second radial bearing 35 and the further bearing 37. This means that the respective spacing is particularly high or can be particularly increased.

In the exemplary embodiment shown in FIGS. 1 to 3, a third transmission stage 38 is provided, which differs from the transmission stages 21, 22 and for example comprises two gears 39, 40. The gears 39, 40 are for example formed as respective spur gears. The gears 39, 40 preferably mesh, in particular directly, with one another. For example, a second of the gears 40 of the third transmission stage 38 is drivable, in particular directly, by a first of the gears 39 of the third transmission stage 38. The third transmission stage 38 is for example part of the first transmission element 19. In the exemplary embodiment shown in FIGS. 1 to 3, in relation to a first torque flow 41 running from the first electric machine 27, in particular via the rotor 31, to the first vehicle wheel 11, the third transmission stage 38 is arranged upstream of the first shaft 4 in the first torque flow 41 between the first electric machine 27, in particular the first rotor 31, and the first vehicle wheel 11. The first shaft 4 can thus be driven, in particular directly, by way of the third transmission stage 38, in particular by way of the second gear 40 of the third transmission stage 38. For example, the second gear 40 of the third transmission stage 38 is arranged on the first shaft 4 and connected for conjoint rotation to the first shaft 4.

In a further embodiment, a fourth transmission stage 42 is provided, which differs in particular from the transmission stages 21, 22, 38 and for example comprises two gears 43, 44. The gears 43, 44 of the fourth transmission stage 42 are for example each formed as spur gears. A first of the gears 43 of the fourth transmission stage 42 preferably meshes, in particular directly, with the second of the gears 44 of the fourth transmission stage 42. For example, the second gear 44 of the fourth transmission stage 42 is drivable, in particular directly, by the first gear 43 of the fourth transmission stage 42. In the exemplary embodiment shown in FIGS. 1 to 3, in relation to a second torque flow 45 running from the second electric machine 28, in particular via the second rotor 32, to the second vehicle wheel 12, the fourth transmission stage 42 is arranged upstream of the second shaft 5 in the second torque flow 45 between the second electric machine 28, in particular the second rotor 32, and the second vehicle wheel 12. The second shaft 5 can thus be driven, preferably directly, by way of the fourth transmission stage 42, in particular by way of the second gear 44. For example, the second gear 44 of the fourth transmission stage 42 is arranged on the fifth shaft 5 and connected for conjoint rotation to the fifth shaft 5. The respective shaft 4, 5 is thus for example formed as a respective “final drive shaft” for driving the respective vehicle wheel 11, 12.

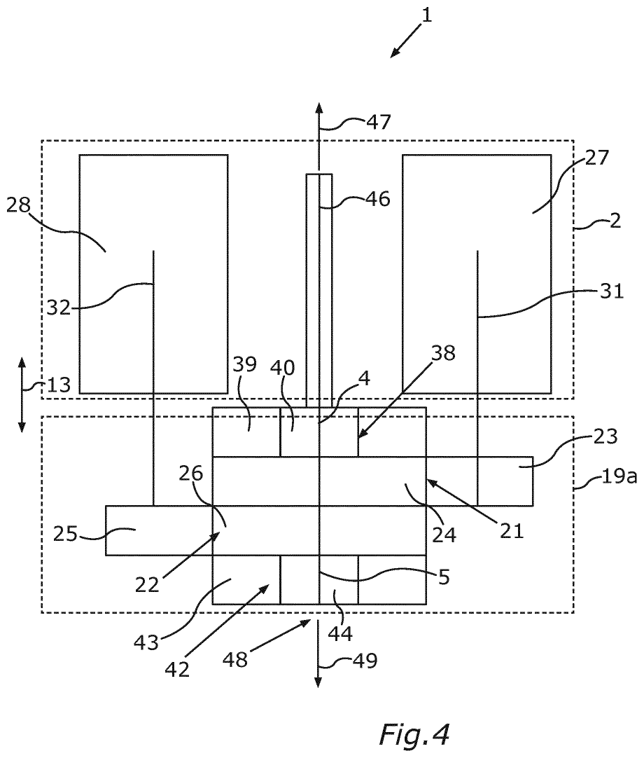

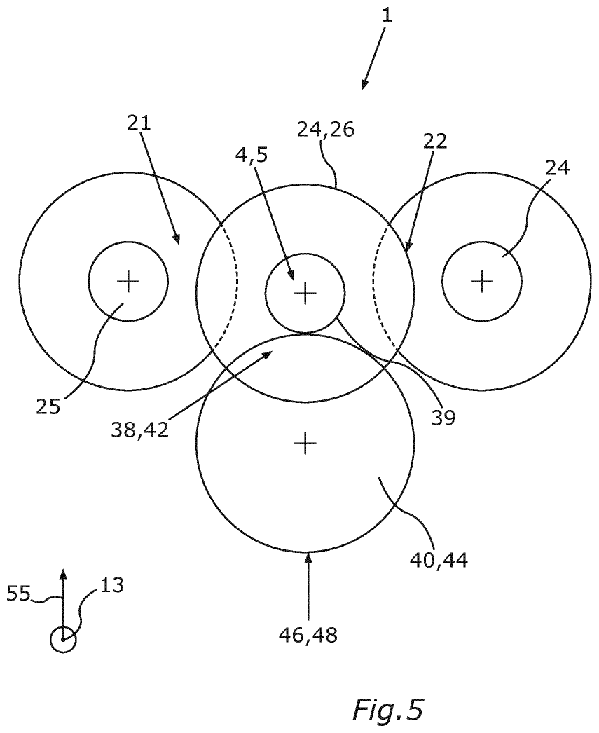

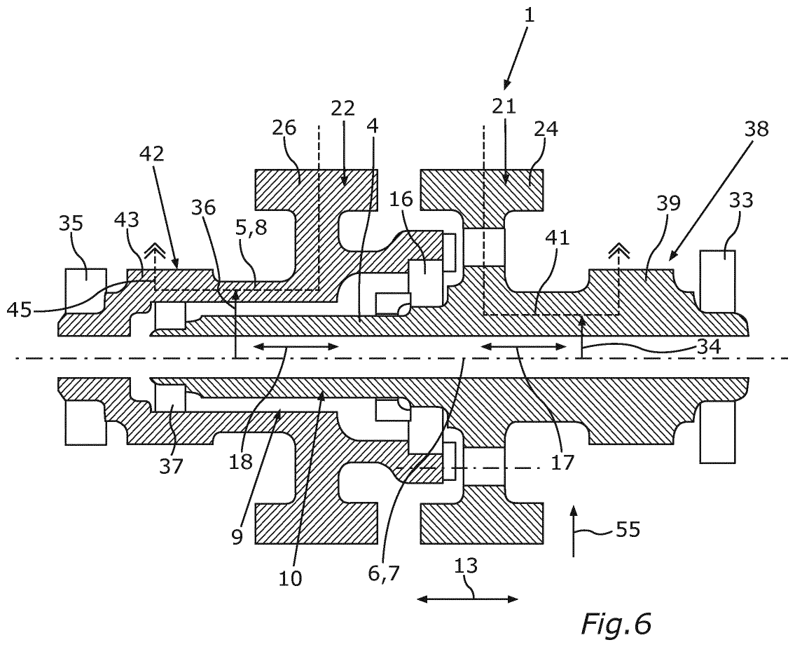

FIG. 4, FIG. 5 and FIG. 6 each show the powertrain 1 according to a further embodiment. FIG. 4 shows the powertrain 1 in a schematic partial sectional view. FIG. 5 shows the powertrain 1 in a schematic lateral partial sectional view. FIG. 6 shows the shafts 4, 5 in a schematic partial sectional view. In the exemplary embodiment shown in FIGS. 4 to 6, in relation to the first torque flow 41, the third transmission stage 38 is arranged downstream of the first shaft 4 in the first torque flow 41 between the first electric machine 27, in particular the first rotor 31, and the first vehicle wheel 11, and, in relation to the second torque flow 45, the fourth transmission stage 42 is arranged downstream of the second shaft 5 in the second torque flow 45 between the second electric machine 28, in particular the second rotor 32, and the second vehicle wheel 12. The respective shaft 4, 5 is thus for example formed as a respective intermediate shaft, in particular as a respective intermediate shaft of the respective transmission element 19, 20.

For example, the first shaft 4 is drivable, in particular directly, by the first transmission stage 21, in particular by the second gear 24 of the first transmission stage 21. For example, the second gear 24 of the first transmission stage 21 is arranged on the first shaft 4 and connected for conjoint rotation to the first shaft 4. For example, the third transmission stage 38, in particular the first gear 39 of the third transmission stage 38, is drivable, in particular directly, by the first shaft 4. For example, the first gear 39 of the fourth transmission stage 38 is arranged on the fourth shaft 4 and connected for conjoint rotation to the fourth shaft 4. The first gear 39 of the third transmission stage 38 is thus for example formed as a pinion arranged on the first shaft 4. For example, the powertrain 1 comprises a third shaft 46, which is formed separately from the shafts 4, 5 and is drivable by way of the third transmission stage 38, and thus in particular by way of the first shaft 4. For example, the second gear 40 of the third transmission stage 38 is arranged on the fourth shaft 46 and connected for conjoint rotation to the fourth shaft 46. The first vehicle wheel 11 can thus be driven by way of the third shaft 46, this being illustrated in FIG. 4 by way of an arrow 47. The third shaft 46 is thus for example formed as a “final drive shaft”. In particular, the first vehicle wheel 11 is drivable by way of the first shaft 4, the third transmission stage 38 and the third shaft 46.

For example, the second shaft 5 is drivable, in particular directly, by way of the second transmission stage 22, in particular by way of the second gear 26 of the second transmission stage 22. For example, the second gear 26 of the second transmission stage 22 is arranged on the second shaft 5 and connected for conjoint rotation to the second shaft 5. For example, the fourth transmission stage 42, in particular the first gear 43 of the fourth transmission stage 42, is drivable, in particular directly, by way of the second shaft 5. For example, the first gear 43 of the second transmission stage 42 is arranged on the second shaft 5 and connected for conjoint rotation to the second shaft 5. The first gear 43 of the second transmission stage 42 is thus for example formed as a pinion arranged on the second shaft 5. For example, the powertrain 1 comprises a fourth shaft 48 which is formed separately from the shafts 4, 5, 46. The fourth shaft 48 is preferably drivable, for example directly, by way of the fourth transmission stage 42, in particular by way of the second gear 44 of the fourth transmission stage 42. For example, the fourth gear 44 of the second transmission stage 42 is arranged on the fourth shaft 48 and connected for conjoint rotation to the fourth shaft. For example, the second vehicle wheel 12 is drivable by way of the fourth shaft 48, this being illustrated in FIG. 4 by way of an arrow 49. The fourth shaft 48 is thus for example formed as a “final drive shaft”. In particular, the second vehicle wheel 12 is drivable by way of the second shaft 5, the fourth transmission stage 42 and the fourth shaft 48.

In a further embodiment, the gears 23, 24 of the first transmission stage 21 and/or the gears 25, 26 of the second transmission stage 22 and/or the gears 39, 40 of the third transmission stage 38 and/or the gears 43, 44 of the fourth transmission stage 42 each have a respective helical toothing 50. A force which is brought about by the respective helical toothing 50, is illustrated in FIG. 1 by way of a respective arrow 51, 52 and is applied to the respective shaft in the respective axial direction 17, 18 thereof can be supported in the respective axial bearing, in particular in the axial bearing 16.

In a further embodiment, at least one of the gears 23, 24 of the first transmission stage 21 and/or at least one of the gears 39, 40 of the third transmission stage 38 is arranged in a first receiving region 53 which is at least partially delimited by the housing element 3, and at least one of the gears 25, 26 of the second transmission stage 22 and/or at least one of the gears 43, 44 of the fourth transmission stage 42 is arranged in a second receiving region 54 which is at least partially delimited by the housing element 3. The receiving regions 53, 54 are preferably spaced apart from one another, in particular in the vehicle transverse direction 13. Preferably, the receiving regions 53, 54 are fluidically connected or connectable, in particular directly, to one another by way of at least one passage opening 56, 57 which is arranged in particular in the vehicle vertical direction 55 below the shafts 4, 5. In the exemplary embodiment shown in FIG. 1, two passage openings 56, 57 are provided, which are preferably arranged in the housing element 3. This makes it possible for a fluid received in the respective receiving region 53, 54 to be exchanged between the receiving regions 53, 54 via the respective passage opening 56, 57. For example, the fluid is air. This makes it possible to provide only one, in particular exactly one, housing ventilation system for the powertrain 1 or for the housing element 3. As an alternative or in addition, the fluid may, for example, be oil. The respective receiving region 53, 54 can thus in particular be a respective reservoir, which can be referred to in particular as oil reservoir.

### LIST OF REFERENCE DESIGNATIONS

1 Powertrain
2 Drive device
3 Housing element
4 First shaft
5 Second shaft
6 First shaft rotational axis
7 Second shaft rotational axis
8 Hollow shaft
9 Receiving space
10 Length region
11 First vehicle wheel
12 Second vehicle wheel
13 Vehicle transverse direction
14 First connecting element
15 Second connecting element
16 Axial bearing
16a Arrow
16b Arrow
17 Axial direction
18 Axial direction
19 First transmission element
20 Second transmission element
21 First transmission stage
21a Input shaft
22 Second transmission stage
22a Input shaft
23 First gear of the first transmission stage
24 Second gear of the first transmission stage
25 First gear of the second transmission stage
26 Second gear of the second transmission stage
27 First electric machine
28 Second electric machine
29 First stator
30 Second stator
31 First rotor
32 Second rotor
33 First radial bearing
33a Arrow
34 Radial direction
35 Second radial bearing
35a Arrow
36 Radial direction
37 Bearing
38 Third transmission stage
39 First gear of the third transmission stage
40 Second gear of the third transmission stage
41 First torque flow
42 Fourth transmission stage
43 First gear of the fourth transmission stage
44 Second gear of the fourth transmission stage
45 Second torque flow
46 Third shaft
47 Arrow
48 Fourth shaft
49 Arrow
50 Helical toothing
51 Arrow
52 Arrow
53 First receiving region
54 Second receiving region
55 Vehicle vertical direction
56 Passage opening
57 Passage opening

1.-10. (canceled)

11. A powertrain for a motor vehicle, comprising:
at least one electric drive device by way of which the motor vehicle is drivable,
a first shaft which is rotatable relative to a housing element,
a second shaft which is rotatable relative to the housing element and is formed at least in certain regions as a hollow shaft in which at least one length region of the first shaft is received so as to be rotatable relative to the second shaft,
wherein, for driving the motor vehicle, the electric drive device is able to be used to drive a first vehicle wheel of the motor vehicle by way of the first shaft,
wherein, for driving the motor vehicle, the electric drive device is able to be used to drive a second vehicle wheel of the motor vehicle by way of the second shaft, and
an axial bearing which bears against the first and the second shaft and supports the shafts in their respective axial directions on one another so as to be rotatable relative to one another.

12. The powertrain according to claim 11, wherein
in relation to the two vehicle wheels, the electric drive device is able to be used to drive exclusively the first vehicle wheel by way of the first shaft, and, in relation to the two vehicle wheels, the electric drive device is able to be used to drive exclusively the second vehicle wheel by way of the second shaft.

13. The powertrain according to claim 11, wherein
the axial bearing is arranged within the hollow shaft.

14. The powertrain according to claim 11, further comprising
at least a first transmission stage, which is able to drive the first shaft by way of the electric drive device, and at least a second transmission stage, which differs from the first transmission stage and is able to drive the second shaft by way of the electric drive device.

15. The powertrain according to claim 11, wherein
the electric drive device comprises a first electric machine, which, in relation to the two shafts, is able to be used to drive exclusively the first shaft, and a second electric machine, which, in relation to the two shafts, is able to be used to drive exclusively the second shaft.

16. The powertrain according to claim 11, further comprising
a first radial bearing, which bears against the first shaft and the housing element and supports the first shaft in its radial direction on the housing element, and a second radial bearing, which bears against the second shaft and the housing element and supports the second shaft in its radial direction on the housing element.

17. The powertrain according to claim 11, wherein
a further bearing which is formed separately from the axial bearing and supports the shafts on one another so as to be rotatable relative to one another is arranged within the hollow shaft.

18. The powertrain according to claim 11, wherein
the respective transmission stage in each case comprises two gears, each of which has a respective helical toothing.

19. The powertrain according to claim 11, wherein
at least a third transmission stage, which differs from the transmission stages and, in relation to a first torque flow running from the first electric machine to the first vehicle wheel, is arranged upstream or downstream of the first shaft in the first torque flow between the first electric machine and the first vehicle wheel, and
at least a fourth transmission stage, which differs from the transmission stages and, in relation to a second torque flow running from the second electric machine to the second vehicle wheel, is arranged upstream or downstream of the second shaft in the second torque flow between the second electric machine and the second vehicle wheel.

20. The powertrain according to claim 14, wherein
at least one gear of the first transmission stage is arranged in a first receiving region which is at least partially delimited by the housing element, and at least one gear of the second transmission stage is arranged in a second receiving region which is at least partially delimited by the housing element and is spaced apart from the first receiving region, wherein the receiving regions are fluidically connected or connectable to one another by way of at least one passage opening.
